(19) United States
(12) Patent Application Publication
(10) Pub. No.: US 2011/0296313 A1
(43) Pub. Date: Dec. 1, 2011

(54) TRANSLATING INPUT FROM DEVICES TO APPROPRIATE RUI COMMANDS

(75) Inventor: David G. Gaxiola, San Jose, CA (US)

(73) Assignee: SONY CORPORATION, Tokyo (JP)

(21) Appl. No.: 12/786,846

(22) Filed: May 25, 2010

(51) Int. Cl. G06F 3/01

(52) U.S. Cl. 715/744

(57) ABSTRACT

A method for mapping input from input devices used for controlling a device to appropriate Remote User Interface (RUI) commands to be transmitted to an RUI server for controlling the device is described herein. An intelligent mapping of commands to exchange input button and feature information between an RUI client and the RUI server is utilized. The mapping enables an input device to communicate with the RUI client device using the RUI server where the RUI client device maps commands and other data.

### FIELD OF THE INVENTION

The present invention relates to the field of user interfaces. More specifically, the present invention relates to translating input from devices to appropriate RUI commands.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

A standard, referred to as Remote User Interface (RUI or Remote UI) is being developed to allow devices to operate each other and provide the user with a user interface that is configured appropriately for a device being used to control another device. For example, a user interface for a television which is 46″ wide is not likely to appear properly on a mobile phone which has a display of 2″. The Remote UI standard is a web-based protocol and framework for remote user interface on UPnP (Universal Plug and Play) Networks and the Internet. The standard allows a UPnP-capable home network device to provide its interface (display and control options) as a web page to display on any other device coupled to the home network.

A Remote UI client is able to be a fully autonomous device that runs its own interface in addition to executing remoted UIs, or it may be a fully remoted device with no local UI capability.

Controlling devices vary widely in size and capabilities. One user interface design will not work for all controlling devices. In the past, controlled devices have tried to export several user interface designs such as a website that exports “full,” “mobile” and “text” versions. The controlling device selects one and attempts to “make it fit” generating user interfaces that are poorly designed for the controlling device, hard for users to use/understand and that do not take advantage of the controlling device's capabilities. Supporting multiple user interfaces from the controlled device also puts an unreasonable load on the device and requires software updates to add new customizations. User generated customizations are usually not possible as many consumer devices cannot be updated by the user.

Further, each device or device manufacturer family generally have their own, typically proprietary input device. These usually feature both a standard set of buttons either from generic functionality (play, pause, fast forward) or standard specific (Blu-ray® player color buttons) as well as proprietary buttons for specialized menus or features. How to convey the supported set of inputs or map existing controls through a remote user interface has traditionally been problematic. Protocol standards like HDMI CEC only address part of the problem such as discovery and communication transport but not the content itself.

### SUMMARY OF THE INVENTION

A method for mapping input from input devices used for controlling a device to appropriate Remote User Interface (RUI) commands to be transmitted to an RUI server for controlling the device is described herein. An intelligent mapping of commands to exchange input button and feature information between an RUI client and the RUI server is utilized. The mapping enables an input device to communicate with the RUI client device using the RUI server , where the RUI client device maps commands and other data.

In one aspect, a method of mapping programmed in a controller in a device comprises sending an input command, mapping the input command to a remote user interface command and outputting the remote user interface command. Sending the input command is by an input device in an input device command format. Mapping the input command is by one of a rendering device and an input device. Outputting the remote user interface command is to a rendering device in a rendering device command format. The method further comprises rendering the remote user interface command on a rendering device. The input command and the remote user interface command are disparate formats. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a method of mapping programmed in a controller in a device comprises receiving a pre-existing association of remote user interface control functions to server commands, automatically mapping input device buttons to the remote user interface control functions and presenting an interface to a user for mapping additional input device buttons not automatically mapped and for enabling the user to re-map any of the automatically mapped buttons. A server sends the pre-existing association to the device. The device is selected from the group consisting of a rendering device and an input device.

In another aspect, a system for mapping programmed in a controller in a device comprises a mapping module maps server application functions to input device buttons and a configuration module presents to a user an interface for mapping remaining buttons and re-mapping already mapped buttons. The server applications functions receive an instruction in a first format and the input device buttons send the instruction in a second format. The first format and the second format are disparate formats. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In yet another aspect, a network of devices comprises an input device for providing an input command, a server device for executing a remote user interface command and a rendering device for mapping an input command to the remote user interface command and for rendering the remote user interface command. The rendering device comprises a mapping structure including a set of input commands and a set of remote user interface commands. The input command is in an input device command format. The remote user interface command is in a rendering device command format. The input command and the remote user interface command are disparate formats.

In still yet another aspect, a rendering device comprises a memory for storing an application, the application for receiving an input command, mapping the input command to a remote user interface command and outputting the remote user interface command and a processing component coupled to the memory, the processing component configured for processing the application. The rendering device comprises a mapping structure including a set of input commands and a set of remote user interface commands. The input command is in an input device command format. The remote user interface command is in a rendering device command format. The input command and the remote user interface command are disparate formats.

### BRIEF DESCRIPTION OF THE DRAWINGS

FIG. 1 illustrates a network of devices utilizing mapping to enable a device to control another device according to some embodiments.

FIG. 2 illustrates a flowchart of a method of utilizing mapping to translate input device commands to a server's command protocol according to some embodiments.

FIG. 3 illustrates a mapping structure according to some embodiments.

FIG. 4 illustrates a block diagram of an exemplary computing device configured to implement the mapping method according to some embodiments.

### DETAILED DESCRIPTION OF THE PREFERRED EMBODIMENT

A method for mapping input from input devices used for controlling a device to appropriate Remote User Interface (RUI) commands to be transmitted to an RUI server for controlling the device is described herein. Rendering devices usually include a proprietary input device (e.g. a television remote control) which have a standard set of buttons for generic functionality and are also able to have proprietary buttons for specific features. This leads to the problem of only being able to use the one input device for controlling the rendering device. An intelligent mapping of commands to exchange input button and feature information between an RUI client and an RUI server is utilized. The mapping enables an RUI client device to properly convey the incoming input device button presses into messages to the RUI server for controlling the device. The user is able to make use of the input device associated with the RUI client device instead of using a different input device directly with the RUI server. For example, ASCII characters are mapped to InfraRed (IR) commands. Further, the RUI client is able to offer a setup option to configure any different or non-existent buttons.

An implementation includes the RUI server providing a set of well known button names, which are agreed upon or standardized numerical or textual identifiers for each function, mapped to a particular code (single or multi-byte binary value, ASCII value or another value) upon coupling by the RUI client (also referred to as a rendering device). The RUI client has its own knowledge of the input device associated and the buttons which are available. At a minimum, the RUI client is able to perform a direct mapping operation between the codes of the native input device to the corresponding codes of the RUI server when the input device events are received. To support different or non-existing buttons, the RUI client offers a setup or configuration option to allow the assignment of buttons or button combinations to the RUI server's named buttons. The configuration is able to be persisted for subsequent sessions.

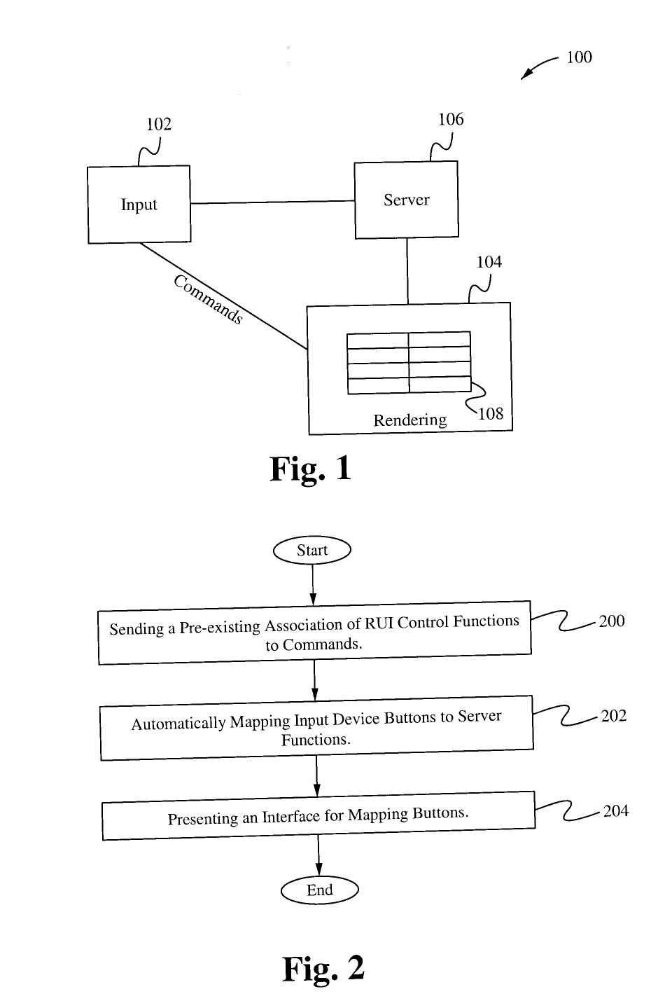

FIG. 1 illustrates a network of devices 100 utilizing mapping to enable a device to control another device according to some embodiments. An input device 102, a rendering device 104, and a server 106 are operatively coupled. In some embodiments, the devices are directly coupled, for example, the input device 102 is able to be coupled to the server 106 and the rendering device 104. Any configuration of the devices is possible, for example, in some embodiments, the input device 102 communicates directly with the rendering device 104, and the rendering device 104 communicates directly with the server 106.

The input device 102 is able to be any computing device capable of communicating information such as sending a command to the rendering device 104 and/or the server 106. In some embodiments the input device 102 is able to perform mapping as well. In some embodiments, the input device 102 communicates directly with the rendering device 104. The communication between the input device 102 and the rendering device 104 and/or the server 106 is through any means such as infrared, radio frequency and Bluetooth®.

For example, a mobile phone is able to be used as a remote control for the television with the functionality of turning the television on/off, changing channels, changing volume, changing television settings and any other functions that the television has.

The rendering device 104 is able to be any computing device capable of rendering information. In some embodiments, the rendering device 104 is also capable of storing and mapping data. For example, in some embodiments, the rendering device 104 also includes a map 108 and mapping data. In some embodiments, the rendering device 104 receives a pre-existing association of RUI control functions to actual commands from the server 106. The rendering device 104 automatically maps buttons of the input device 102 whose functionality directly correspond to the server's provided functions. In some embodiments, the rendering device 104 or the input device 102 present to the user a graphical or other interface for mapping the remaining buttons or re-mapping already mapped buttons to the remaining server functionality. In some embodiments, local and/or online systems are able to determine optimum mappings for buttons.

The server 106 is able to be any computing device capable of executing functions. In some embodiments, the server 106 stores and sends data such as a pre-existing association of RUI control functions to actual commands to the rendering device 104. In some embodiments, the server 106 is capable of storing, serving and mapping data. In some embodiments, the information stored on the server 106 includes the map 108 and mapping data. Furthermore, the server 106 is able to be one or more servers which are able to act jointly or independently of each other.

In some embodiments, the map 108 is stored on any of the input device 102, the rendering device 104 and the server 106. In some embodiments, the input device 102 and the rendering device 104 are able to communicate directly using the map 108 stored on either or both of them without using the server 106.

In some embodiments, the input device 102, a rendering device 104, and a server 106 are coupled through a network. The network is able to be any type of network such as a Local Area Network (LAN), a Wide Area Network (WAN), the Internet, a network of networks or any other network. Additionally, the type of network is able to be wireless, wired, cellular, any other type of network or any combination of two or more networks. In some embodiments, a network is not used and devices are directly coupled. Although the network of devices 100 shown includes an input device, a server and a rendering device, any number of input devices and/or rendering devices is possible, for example one input device and multiple rendering devices.

FIG. 2 illustrates a flowchart of a method of utilizing mapping to translate input device commands to a server's command protocol according to some embodiments. In the step 200, a server sends a pre-existing association of RUI control functions to actual commands to a rendering device. In the step 202, the rendering device automatically maps input device buttons whose functionality directly correspond to the server's provided functions. In the step 204, the rendering device (or the input device) presents to the user a graphical or other interface for mapping the remaining buttons or re-mapping already mapped buttons to the remaining server functionality. The mappings are then able to be used to implement functionality available through the server. For example, the rendering device renders an RUI using the mappings. In a more detailed example of utilizing the method described herein, an input command (e.g. button press) is mapped to an RUI application control command which results in the server's application issuing an RUI rendering command which results in the rendering device updating the user interface. An example of an RUI rendering command from the server is “display text ABC,” “draw box at X,Y,” or “display graphic J at X,Y.” Although specific steps are described, in some embodiments, fewer or more steps are included, and/or the order of the steps is able to be changed.

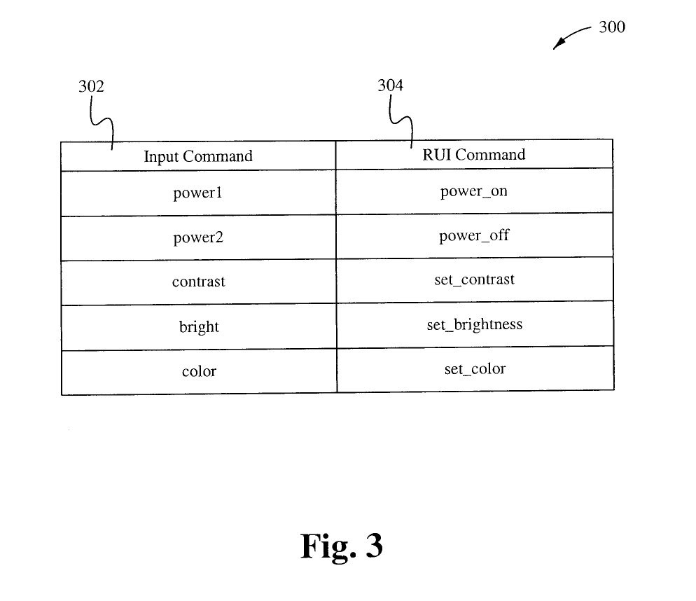

FIG. 3 illustrates a mapping structure 300 according to some embodiments. The mapping structure 300 includes input commands 302 and RUI rendering commands 304. In some embodiments, the mapping shown in the mapping structure 300 is the final outcome of the mapping process. When the input command 302 is received, the rendering device or other device is able to communicate the RUI rendering command in a language or format that the server is able to understand. The mapping structure 300 and its contents are an example and are able to be modified as desired. Some input commands and RUI rendering commands may not be mapped to one another. Further, the mapping of the input commands 302 and the RUI commands 304 are able to be obvious (e.g. power1->power_on) or less obvious (e.g. red->record_start).

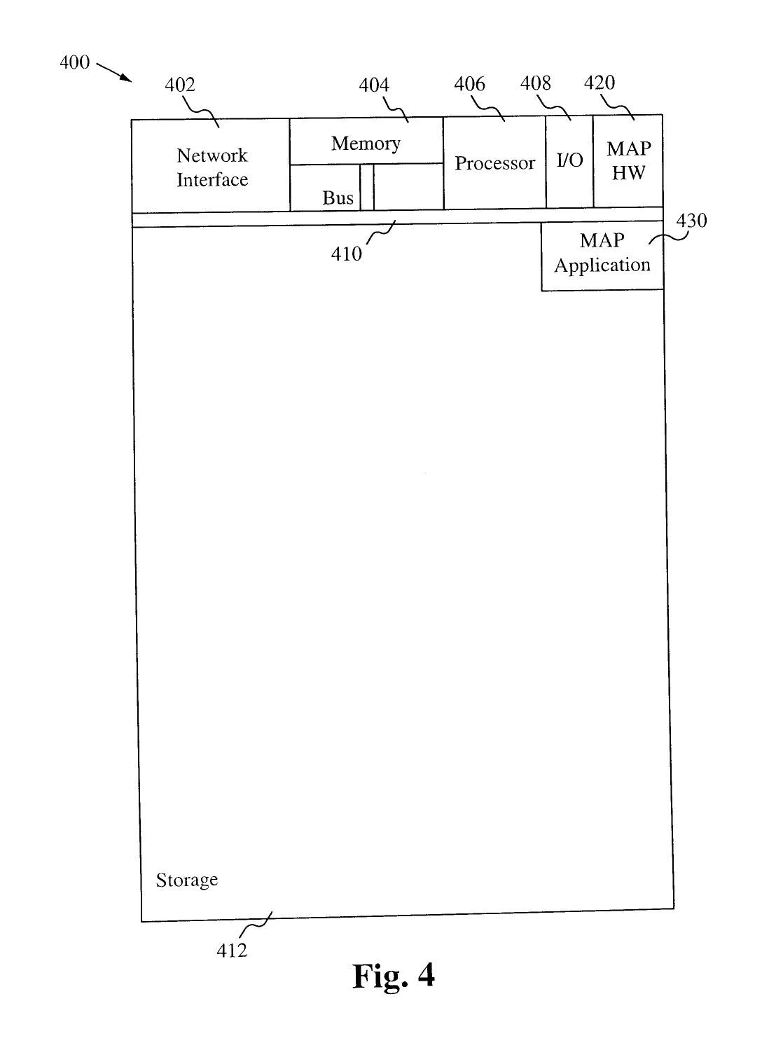

FIG. 4 illustrates a block diagram of an exemplary computing device 400 configured to implement the mapping method according to some embodiments. The computing device 400 is able to be used to send, acquire/receive, store, compute, communicate, map and/or display information. For example, the computing device 400 is able to utilize a mapping structure to map commands of one format/language/protocol to another format/language/protocol. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, Blu-ray®, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, display, printer, modem, touchscreen, button interface and other devices. Mapping application(s) 430 used to perform the mapping method are likely to be stored in the storage device 412 and memory 404 and processed as applications are typically processed. More or less components shown in FIG. 4 are able to be included in the computing device 400. In some embodiments, mapping hardware 420 is included. Although the computing device 400 in FIG. 4 includes applications 430 and hardware 420, the mapping method is able to be implemented on a computing device in hardware, firmware, software or any combination thereof. For example, in some embodiments, the mapping applications 430 are programmed in a memory and executed using a processor. In another example, in some embodiments, the mapping hardware 420 is programmed hardware logic including gates specifically designed to implement the mapping method.

In some embodiments, the mapping application(s) 430 include several applications and/or modules. As described herein, a mapping module maps server application functions to input device functions or buttons and a configuration module presents to the user an interface for mapping remaining buttons or re-mapping already mapped buttons. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information. In some embodiments, the computing devices include a combination of devices. For example, an input device is able to include a Blu-Ray® Disc remote and a Playstation® 3 console, an IR remote and a television, and other combinations of devices.

The input device, the rendering device and the server are all able to be any of these computing devices and any other devices that would benefit from the description herein. In some embodiments, the input device and the rendering device are the same device. In some embodiments, the input device is tightly coupled with the rendering device such as a remote that only works with a particular television.

To utilize the mapping method, a user communicates a command from an input device to a rendering device. The command is mapped to server functionality which displays the RUI update to the rendering device. The mapping occurs automatically, and the user generally experiences being able to remotely control a device with another device seamlessly.

In operation, the mapping method is able to map an input command in one language/format/protocol to another language/format/protocol. By mapping the command, an input device that typically would not be able to communicate with a rendering device or a server device is now able to communicate. This enables a rendering device to utilize many other devices beyond the standard device that is purchased with the rendering device. For example, instead of a television using the remote that is purchased with it or a universal remote, a device that communicates using its own implementation is able to have its communications mapped to communications receivable by the television.

In some embodiments, the devices implemented within the network described herein are able to implement Digital Living Network Alliance (DLNA) standard, UPnP and/or the Remote UI standard. In some embodiments, the devices implemented within the network described herein do not implement Digital Living Network Alliance (DLNA) standard, UPnP and/or the Remote UI standard.

Some Embodiments of Translating Input from Devices to Appropriate RUI Commands
1. A method of mapping programmed in a controller in a device comprising:
   a. sending an input command;
   b. mapping the input command to a remote user interface command; and
   c. outputting the remote user interface command.
2. The method of clause 1 wherein sending the input command is by an input device in an input device command format.
3. The method of clause 1 wherein mapping the input command is by one of a rendering device and an input device.
4. The method of clause 1 wherein outputting the remote user interface command is to a rendering device in a rendering device command format.
5. The method of clause 1 further comprising rendering the remote user interface command on a rendering device.
6. The method of clause 1 wherein the input command and the remote user interface command are disparate formats.
7. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
8. A method of mapping programmed in a controller in a device comprising:
   a. receiving a pre-existing association of remote user interface control functions to server commands;
   b. automatically mapping input device buttons to the remote user interface control functions; and
   c. presenting an interface to a user for mapping additional input device buttons not automatically mapped and for enabling the user to re-map any of the automatically mapped buttons.
9. The method of clause 8 wherein a server sends the pre-existing association to the device.
10. The method of clause 8 wherein the device is selected from the group consisting of a rendering device and an input device.
11. A system for mapping programmed in a controller in a device comprising:
   a. a mapping module maps server application functions to input device buttons; and
   b. a configuration module presents to a user an interface for mapping remaining buttons and re-mapping already mapped buttons.
12. The system of clause 11 wherein the server applications functions receive an instruction in a first format and the input device buttons send the instruction in a second format.
13. The system of clause 11 wherein the first format and the second format are disparate formats.
14. The system of clause 11 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
15. A network of devices comprising:
   a. an input device for providing an input command;
   b. a server device for executing a remote user interface command; and
   c. a rendering device for mapping an input command to the remote user interface command and for rendering the remote user interface command.
16. The network of devices of clause 15 wherein the rendering device comprises a mapping structure including a set of input commands and a set of remote user interface commands.
17. The network of devices of clause 15 wherein the input command is in an input device command format.
18. The network of devices of clause 15 wherein the remote user interface command is in a rendering device command format.
19. The network of devices of clause 15 wherein the input command and the remote user interface command are disparate formats.
20. A rendering device comprising:
   a. a memory for storing an application, the application for:
      i. receiving an input command;
      ii. mapping the input command to a remote user interface command; and
      iii. outputting the remote user interface command; and
   b. a processing component coupled to the memory, the processing component configured for processing the application.
21. The rendering device of clause 20 wherein the rendering device comprises a mapping structure including a set of input commands and a set of remote user interface commands.
22. The rendering device of clause 20 wherein the input command is in an input device command format.
23. The rendering device of clause 20 wherein the remote user interface command is in a rendering device command format.
24. The rendering device of clause 20 wherein the input command and the remote user interface command are disparate formats.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of mapping programmed in a controller in a device comprising:
a. sending an input command;
b. mapping the input command to a remote user interface command; and
c. outputting the remote user interface command.

2. The method of claim 1 wherein sending the input command is by an input device in an input device command format.

3. The method of claim 1 wherein mapping the input command is by one of a rendering device and an input device.

4. The method of claim 1 wherein outputting the remote user interface command is to a rendering device in a rendering device command format.

5. The method of claim 1 further comprising rendering the remote user interface command on a rendering device.

6. The method of claim 1 wherein the input command and the remote user interface command are disparate formats.

7. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

8. A method of mapping programmed in a controller in a device comprising:
a. receiving a pre-existing association of remote user interface control functions to server commands;
b. automatically mapping input device buttons to the remote user interface control functions; and
c. presenting an interface to a user for mapping additional input device buttons not automatically mapped and for enabling the user to re-map any of the automatically mapped buttons.

9. The method of claim 8 wherein a server sends the pre-existing association to the device.

10. The method of claim 8 wherein the device is selected from the group consisting of a rendering device and an input device.

11. A system for mapping programmed in a controller in a device comprising:
a. a mapping module maps server application functions to input device buttons; and
b. a configuration module presents to a user an interface for mapping remaining buttons and re-mapping already mapped buttons.

12. The system of claim 11 wherein the server applications functions receive an instruction in a first format and the input device buttons send the instruction in a second format.

13. The system of claim 11 wherein the first format and the second format are disparate formats.

14. The system of claim 11 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

15. A network of devices comprising:
a. an input device for providing an input command;
b. a server device for executing a remote user interface command; and
c. a rendering device for mapping an input command to the remote user interface command and for rendering the remote user interface command.

16. The network of devices of claim 15 wherein the rendering device comprises a mapping structure including a set of input commands and a set of remote user interface commands.

17. The network of devices of claim 15 wherein the input command is in an input device command format.

18. The network of devices of claim 15 wherein the remote user interface command is in a rendering device command format.

19. The network of devices of claim 15 wherein the input command and the remote user interface command are disparate formats.

20. A rendering device comprising:
a. a memory for storing an application, the application for:
i. receiving an input command;
ii. mapping the input command to a remote user interface command; and
iii. outputting the remote user interface command; and
b. a processing component coupled to the memory, the processing component configured for processing the application.

21. The rendering device of claim 20 wherein the rendering device comprises a mapping structure including a set of input commands and a set of remote user interface commands.

22. The rendering device of claim 20 wherein the input command is in an input device command format.

23. The rendering device of claim 20 wherein the remote user interface command is in a rendering device command format.

24. The rendering device of claim 20 wherein the input command and the remote user interface command are disparate formats.
